(19) United States
(12) Patent Application Publication
(10) Pub. No.: US 2026/0265497 A1
(43) Pub. Date: Sep. 10, 2026

(54) POLYBUTYLENE TEREPHTHALATE COMPOSITION FOR USE IN HIGH-FREQUENCY RADIO-WAVE APPLICATIONS

(71) Applicant: SABIC Global Technologies B.V., Bergen op Zoom (NL)

(72) Inventors: Pradipta Nayak, Bengaluru (IN); Suresh Velate, Bengaluru (IN); Dhanabalan Anantharaman, Bengaluru (IN)

(21) Appl. No.: 18/867,990

(22) PCT Filed: May 25, 2023
(86) PCT No.: PCT/EP2023/064099

§ 371 Date: Nov. 21, 2024

(30) Foreign Application Priority Data
May 27, 2022 (EP) 22175709.9

(51) Int. Cl. C08K 7/28; C08K 7/08; C08K 7/14; C08L 67/02

(52) U.S. Cl. CPC C08K 7/28; C08K 7/08; C08K 7/14; C08L 67/02; C08K 2201/003; C08K 2201/004; C08K 2201/005

(57) ABSTRACT

A polybutylene terephthalate composition for use in high-frequency radio-wave applications of 6 GHz or greater comprises a mixture of a polybutylene terephthalate and hollow glass bubbles having an average diameter or particle size of from 5 μm to 80 μm. The polybutylene terephthalate composition further includes at least one of glass fibers having a length of from 0.5 mm to 10 mm and a width or diameter of from 5 μm to 15 μm, aluminum oxide fibers having a length of from 1 mm to 5 mm and a width or diameter of from 1 μm to 30 μm, a cyclic olefin copolymer, and a polycarbonate. The polybutylene terephthalate composition is prepared by modifying a polybutylene terephthalate by melt blending the polybutylene terephthalate with the various materials.

### TECHNICAL FIELD

The invention relates to polybutylene terephthalate compositions for use in high-frequency radio-wave applications.

### BACKGROUND

The advent of 5G communication technology and related devices has prompted the requirement of low cost and light-weight polymeric materials with low dielectric constant (Dk) and dissipation factor (Df) values, high metal adhesion strength, low coefficient of thermal expansion (CTE), and good mechanical and thermal properties. Currently, FR-4 glass-reinforced epoxy laminate materials are being widely used as the antenna substrate for sub-6 GHz frequency applications. FR-4 laminates are not considered to be suitable for high frequency (i.e., >6 GHz) applications due to the laminate's high Dk (>4) and Df (>0.01) values.

On the other hand, materials such as polytetrafluoroethylene (PTFE), liquid crystal polymer (LCP) and modified polyimide (M-PI) are considered to be suitable materials for higher frequency (>6 GHz) antenna and other sub-segment applications, due to their low Dk and Df values. These materials are very costly, however, and do not meet the light-weight criteria required for the targeted applications, apart from other specific challenges associated with each of these materials. In particular, use of PTFE brings several challenges such as higher system cost, which includes both material and processing costs, and poor metal adhesion, high CTE along the z-axis, and higher density.

In this regard, one can choose other commercially available polymeric materials such as polybutylene terephthalate (PBT), as it has a lower Dk (~3 at 10 GHz) and Df (~0.005 at 10 GHz) compared to FR-4 and it has better metal adhesion properties compared to PTFE. The mechanical and thermal properties of neat PBT, however, are not sufficient enough to meet certain manufacturing process steps and operational conditions, such as surface mount technology (SMT) processes. Though incorporation of certain additives into PBT may improve its mechanical and thermal properties, the dielectric properties and metal adhesion characteristics of PBT may be impacted with these additives.

Accordingly, there is a need to modify PBT with those additives that provide a synergistic effect such that the modified PBT has low Dk and Df values, high metal adhesion strength, low CTE, and good mechanical and thermal properties such that it is suitable for higher frequency (i.e., >6 GHz) applications.

### SUMMARY

A polybutylene terephthalate (PBT) composition for use in high-frequency radio-wave applications of 6 GHz or greater comprises a mixture of a polybutylene terephthalate, hollow glass bubbles having an average diameter of from 5 microns to 80 microns, and at least one of several additives. The additives may include glass fibers having a length of from 0.5 mm to 10 mm and a width or diameter of from 5 microns to 15 microns, aluminum oxide fibers having a length of from 1 mm to 5 mm and a width or diameter of from 1 micron to 30 microns, a polyethylene terephthalate and/or a polycarbonate.

The hollow glass bubbles may be included in the PBT composition in an amount of from 1 wt % to 35 wt %. The hollow glass bubbles may have at least one of a crush strength of 30 MPa or more, a true density of from 0.3 g/cc to 0.8 g/cc, and a gas volume of from 50% to 90%.

The PBT composition may include the glass fibers in an amount of 40 wt % or less by total weight of the composition. The glass fibers may have at least one of a dielectric constant (Dk) of 6 or lower as measured according to ASTM D150 at 6 MHz or higher, a dissipation factor (Df) of 0.005 or less, as measured according to ASTM D150 at 6 MHz or higher, and a coefficient of thermal expansion (CTE) of 35×10⁻⁶/° C. or less, as measured according to ASTM D696.

The PBT composition may also include aluminum oxide fibers in an amount of 40 wt % or less by total weight of the composition.

The PBT may be a low intrinsic viscosity (IV) resin with an IV of 1.4 dl/g or less or a high IV resin with an IV of 1.5 dl/g or more or a mixture of such resins.

The PBT composition may also include polycarbonate in an amount of 30 wt % or less by total weight of the composition and polyethylene terephthalate in an amount of 30 wt % or less by total weight of the composition.

The PBT composition may also include at least one of a stabilizing agent, a coupling agent, a nucleating agent, a heat conductive agent, a fire retardant additive, a thermally conductive additive, a tie agent, an antiblocking agent, an antistatic agent, an antioxidant, a neutralizing agent, an acid scavenger, a blowing agent, a crystallization aid, a dye, a flame retardant agent, a filler, a hard filler, a soft filler, an impact modifier, a mold release agent, an oil, another polymer, a pigment, a processing agent, a reinforcing agent, a light stabilizer, an UV resistance agent, a slip agent, a flow modifying agent, and combinations thereof.

The PBT composition may have a Dk value of 2.5 or less, when measured at 6 GHz or higher, and a Df value of 0.005 or less, when measured at 6 GHz or higher, and may have one or more of a metal adhesion peel strength of 0.1 N/mm or greater, as measured according to ASTM B533 or IPC-TM-650; a coefficient of thermal expansion (CTE) of 35 ppm/° C. or less, as measured according to ASTM D696; a heat deflection temperature (HDT) of 200° C. or greater, as measured according to ASTM D648; water absorption of 0.05 wt % or less, as measured according to ASTM D570; a tensile modulus of 2000 MPa or more, as measured according to ASTM D638; a tensile strength of 35 MPa or more, as measured according to ASTM D638; a density of 1.4 g/cc or less; a UL94 flame retardance rating of V0@1.5 mm; and a thermal conductivity of 0.3 W/mK or less, as measured according to ASTM C518.

The PBT composition is formed into an article of manufacture. The article of manufacture may be a telecommunication device or component, a high frequency (>6 GHz) electrical device, a high frequency (>6 GHz) multi-generational telecommunication device or component, a 5G or higher generation telecommunication device or component, a telecommunication device housing, a radome cover, a radio-frequency (RF) filter, an RF connector, an EMI shield, an antenna substrate, a waveguide substrate or carrier, an antenna substrate in a base station antenna, or an automotive radar component.

In a method of forming a PBT composition for use in high-frequency radio-wave applications of 6 GHz or greater, a polybutylene terephthalate is modified by melt blending the polybutylene terephthalate with materials of hollow glass bubbles having an average diameter of 5 microns to 80 microns, and at least one of several additives that are dispersed throughout the polybutylene terephthalate. These additives may include glass fibers having a length of from 0.5 mm to 10 mm and a width or diameter of from 5 microns to 15 microns, aluminum oxide fibers having a length of from 1 mm to 5 mm and a width or diameter of from 1 micron to 30 microns, and a polycarbonate so that the materials.

### DETAILED DESCRIPTION

Compared to those high-cost materials currently used for high-frequency radio wave applications, polybutylene terephthalate (PBT) is a readily available and relatively low-cost material. PBT has yet to be widely used for high-frequency radio wave applications, however, due to neat PBT's inherent shortcomings at these higher frequencies. In the present invention, PBT is melt blended with a mixture of synergistic additives that overcome these shortcomings and make the PBT composition suitable for use in high-frequency radio-wave applications of 6 GHz or greater.

The modified PBT is tailored so that it is light weight, has a low dielectric constant (Dk), a low dissipation factor (Df), high metal adhesion strength, low coefficient of thermal expansion (CTE), high mechanical strength, and good thermal performance. By using a blend of PBT with those particular additives described herein, these properties can be achieved.

In the co-filed and co-pending patent application entitled “Polypropylene Composition for Use in High-Frequency Radio-Wave Applications,” identified by Attorney Docket No. 21T&I0030, modified polypropylene (PP) for use high-frequency radio-wave 5G applications of 6 GHz or greater was disclosed. While such modified polypropylene may be useful in many such applications, because of the polypropylene's lower melting point (~160° C.) it has limitations with respect to those processing conditions and operations that occur at much higher temperatures, such as during soldering for surface mount technology (SMT) applications. In contrast, PBT has a much higher melting point (~220° C.) so that it can be used for applications that involve higher temperatures, such as SMT.

The PBT component of the polymer blend may constitute homopolymers of polybutylene terephthalate resin. These may be those formed by the polycondensation of a dicarboxylic acid containing terephthalic acid or an ester forming derivative of this, such as a C₁ to C₆ alkyl ester or acid halide or the like, and a glycol component containing alkylene glycol with at least four carbon atoms (e.g., 1,4-butane diol) or an ester-forming derivative thereof.

An example of a suitable commercially available PBT homopolymer is that available as VALOX™ resin 176 or VALOX™ resin 3007, from SABIC USA or SABIC Europe, respectively.

In other embodiments, the PBT component can include copolymers of PBT poly(ethylene glycol (PBT-PET multi-block copolymer), PBT-polyethylene oxide terephthalate (PBT-PEOT block copolymer) PBT-r-butylene dilinoleate (PBT-DLA copolymer), random PBT-PET copolymer with the choice of diol components selected from the group consisting of ethylene glycol, propylene glycol and poly(butylene-1,4-cyclohexane dicarboxylate (PBCD), poly(butylene-1,3-cyclopentane dicarboxylate (PBCP) and poly(butyleneblock-polylactic acid copolymer. When such copolymers are used, the non-butylene terephthalate copolymer unit may be present in the PBT copolymer in an amount of 30 wt % or less, with from 5 wt % to 30 wt % being used in many instances. In particular embodiments, the non-butylene terephthalate copolymer unit may be present in the PBT copolymer in an amount of from at least, equal to, and/or between any two of 0.1 wt %, 0.2 wt %, 0.3 wt %, 0.4 wt %, 0.5 wt %, 0.6 wt %, 0.7 wt %, 0.8 wt %, 0.9 wt %, 1 wt %, 2 wt %, 3 wt %, 4 wt %, 5 wt %, 6 wt %, 7 wt %, 8 wt %, 9 wt %, 10 wt %, 11 wt %, 12 wt %, 13 wt %, 14 wt %, 15 wt %, 16 wt %, 17 wt %, 18 wt %, 19 wt %, 20 wt %, 21 wt %, 22 wt %, 23 wt %, 24 wt %, 25 wt %, 26 wt %, 27 wt %, 29 wt %, and 30 wt %.

In some embodiments, the polybutylene terephthalate composition is substantially free of polytetrafluoroethylene (PTFE). As used herein, the phrase “substantially free” with respect to a component of a composition means that the component is not actively or intentionally added to the composition, but may be present as an impurity in an amount less than about 0.01 % by weight of the composition.

It should be noted in the description, if a numerical value, concentration or range is presented, each numerical value should be read once as modified by the term “about” (unless already expressly so modified), and then read again as not so modified unless otherwise indicated in context. Also, in the description, it should be understood that an amount range listed or described as being useful, suitable, or the like, is intended that any and every value within the range, including the end points, is to be considered as having been stated. For example, “a range of from 1 to 10” is to be read as indicating each and every possible number along the continuum between about 1 and about 10. Thus, even if specific points within the range, or even no point within the range, are explicitly identified or referred to, it is to be understood that the inventor appreciates and understands that any and all points within the range are to be considered to have been specified, and that inventor possesses the entire range and all points within the range, including smaller ranges within the larger ranges.

As discussed throughout the following description, as it relates to the PBT component of the PBT composition, the expression “PBT” is meant to include both PBT homopolymers and PBT copolymers, unless expressly stated otherwise or is otherwise apparent from its context.

The PBT component of the composition can be characterized by various properties such as average molecular weight, density, intrinsic viscosity, melt flow index (MFI), polydispersity index (PDI), tensile strength at yield, tensile modulus, tensile elongation at yield, Izod notched impact strength, hardness or combinations thereof.

The average molecular weight (Mw) of the PBT component may range from 30,000 to 200,000 as determined by high temperature gel permeation chromatography. In particular, the average molecular weight (Mw) of the PBT may be from at least, equal to, and/or between any two of 30,000, 40,000, 50,000, 60,000, 70,000, 80,000, 90,000, 100,000, 110,000, 120,000, 130,000, 140,000, 150,000, 160,000, 170,000, 180,000, 190,000, and 200,000, as determined by high temperature (40-50° C.) gel permeation chromatography using 1,1,1,3,3,3-hexafluoroisopropanol (HFIP as solvent). Unless otherwise specified, all average molecular weights (Mw) for those polymers described herein are those determined by high temperature gel permeation chromatography.

The density of the PBT can be from 1.3 g/cm³ or 1.4 g/cm³. In particular, the density of the PBT may be from at least, equal to, and/or between any two of 1.30 g/cm³, 1.31 g/cm³, 1.32 g/cm³, 1.33 g/cm³, 1.34 g/cm³, 1.35 g/cm³, 1.36 g/cm³, 1.37 g/cm³, 1.38 g/cm³, 1.39 g/cm³, and 1.40 g/cm³.

The PBT can be that having a low intrinsic viscosity (IV) resin with an IV of 1.4 dl/g or less or a high IV resin with IV of 1.5 dl/g or more or a mixture of such PBT resins. The intrinsic viscosity of PBT is measured in dilute solution using capillary viscometers following ISO-1628-5 protocol. In certain embodiments, the low IV PBT can have an IV of at least, equal to, and/or between any two of 0.2 dl/g, 0.3 dl/g, 0.4 dl/g, 0.5 dl/g, 0.6 dl/g, 0.7 dl/g, 0.8 dl/g, 0.9 dl/g, 1.0 dl/g, 1.1 dl/g, 1.2 dl/g, 1.3 dl/g, and 1.4 dl/g. In certain embodiments, the high IV PBT resin can have an IV of at least, equal to, and/or between any two of 1.5 dl/g, 1.6 dl/g, 1.7 dl/g, 1.8 dl/g, 1.9 dl/g, 2.0 dl/g, 2.1 dl/g, 2.2 dl/g, 2.3 dl/g, 2.4 dl/g, and 2.5 dl/g.

When a mixture of such low and high IV PBT resins are used, the low IV PBT resin being used in an amount of from 0.1 wt % to 99.9 wt % by total weight of the low and high IV PBT resins. When a mixture of low and high IV PBT resins are used, the amount of the low IV resin may be at least, equal to, and/or between any two of 0.1 wt %, 0.2 wt %, 0.3 wt %, 0.4 wt %, 0.5 wt %, 0.6 wt %, 0.7 wt %, 0.8 wt %, 0.9 wt %, 1.0 wt %, 1.1 wt %, 1.2 wt %, 1.3 wt %, 1.4 wt %, 1.5 wt %, 1.6 wt %, 1.7 wt %, 1.8 wt %, 1.9 wt %, 2.0 wt %, 2.1 wt %, 2.2 wt %, 2.3 wt %, 2.4 wt %, 2.5 wt %, 2.6 wt %, 2.7 wt %, 2.8 wt %, 2.9 wt %, 3.0 wt %, 3.1 wt %, 3.2 wt %, 3.3 wt %, 3.4 wt %, 3.5 wt %, 3.6 wt %, 3.7 wt %, 3.8 wt %, 3.9 wt %, 4.0 wt %, 4.1 wt %, 4.2 wt %, 4.3 wt %, 4.4 wt %, 4.5 wt %, 4.6 wt %, 4.7 wt %, 4.8 wt %, 4.9 wt %, 5.0 wt %, 5.5 wt %, 6.0 wt %, 6.5 wt %, 7.5 wt %, 8.0 wt %, 8.5 wt %, 9.0 wt %, 9.5 wt %, 10 wt %, 11 wt %, 12 wt %, 13 wt %, 14 wt %, 15 wt %, 16 wt %, 17 wt %, 18 wt %, 19 wt %, 20 wt %, 21 wt %, 22 wt %, 23 wt %, 24 wt %, 25 wt %, 26 wt %, 27 wt %, 28 wt %, 29 wt %, 30 wt %, 31 wt %, 32 wt %, 33 wt %, 34 wt %, 35 wt %, 36 wt %, 37 wt %, 38 wt %, 39 wt %, 40 wt %, 41 wt %, 42 wt %, 43 wt %, 44 wt %, 45 wt %, 46 wt %, 47 wt %, 48 wt %, 49 wt %, 50 wt %, 51 wt %, 52 wt %, 53 wt %, 54 wt %, 55 wt %, 56 wt %, 57 wt %, 58 wt %, 59 wt %, 60 wt %, 61 wt %, 62 wt %, 63 wt %, 64 wt %, 65 wt %, 66 wt %, 67 wt %, 68 wt %, 69 wt %, 70 wt %, 71 wt %, 72 wt %, 73 wt %, 74 wt %, 75 wt %, 76 wt %, 77 wt %, 78 wt %, 79 wt %, 80 wt %, 81 wt %, 82 wt %, 83 wt %, 84 wt %, 85 wt %, 86 wt %, 87 wt %, 88 wt %, 89 wt %, 90 wt %, 91 wt %, 92 wt %, 93 wt %, 94 wt %, 95 wt %, 96 wt %, 97 wt %, 98 wt %, 99 wt %, and 99.9 wt %.

The PBT can have an MFI at 250° C. and 2.16 kg loading of from 0.1 g/10 min to 40/10 min as per ISO 1133, or at least, equal to, and/or between any two of 0.1 g/10 min, 0.2 g/10 min, 0.3 g/10 min, 0.4 g/10 min, 0.5 g/10 min, 0.6 g/10 min, 0.7 g/10 min, 0.8 g/10 min, 0.9 g/10 min, 1 g/10 min, 2 g/10 min, 3 g/10 min, 4 g/10 min, 5 g/10 min, 6 g/10 min, 7 g/10 min, 8 g/10 min, 9 g/10 min, 10 g/10 min, 11 g/10 min, 12 g/10 min, 13 g/10 min, 14 g/10 min, 15 g/10 min, 16 g/10 min, 17 g/10 min, 18 g/10 min, 19 g/10 min, and 20 g/10 min, 21 g/10 min, 22 g/10 min, 23 g/10 min, 24 g/10 min, 25 g/10 min, 26 g/10 min, 27 g/10 min, 28 g/10 min, 29 g/10 min, 30 g/10 min, 31 g/10 min, 32 g/10 min, 33 g/10 min, 34 g/10 min, 35 g/10 min, 36 g/10 min, 37 g/10 min, 38 g/10 min, 39 g/10 min, and 40 g/10 min, as per ISO 1133.

The PBT component may have a polydispersity index (PDI=Mw/Mn) of from 2 to 10, as determined by high temperature gel permeation chromatography, or at least, equal to, and/or between any two of 2.0, 2.1, 2.2, 2.3, 2.4, 2.5, 2.6, 2.7, 2.8, 2.9, 3.0, 3.0, 3.1, 3.2, 3.3, 3.4, 3.5, 3.6, 3.7, 3.8, 3.9, 4.0, 4.1, 4.2, 4.3, 4.4, 4.5, 4.6, 4.7, 4.8, 4.9, 5.0, 5.1, 5.2, 5.3, 5.4, 5.5, 5.6, 5.7, 5.8, 5.9, 6.0, 6.1, 6.2, 6.3, 6.4, 6.5, 6.6, 6.7, 6.8, 6.9, 7.0, 7.1, 7.2, 7.3, 7.4, 7.5, 7.6, 7.7, 7.8, 7.9, 8.0, 8.1, 8.2, 8.3, 8.4, 8.5, 8.6, 8.7, 8.8, 8.9, 9.0, 9.1, 9.2, 9.3, 9.4, 9.5, 9.6, 9.7, 9.8, 9.9, and 10.0.

Tensile modulus of the PBT can be from 1700 MPa to 3000 MPa, or at least, equal to, and/or between any two of 1700 MPa, 1750 MPa, 1800 MPa, 1850 MPa, 1900 MPa, 1950 MPa, 2000 MPa, 2050 MPa, 2100 MPa, 2150 MPa, 2200 MPa, 2250 MPa, 2300 MPa, 2350 MPa, 2400 MPa, 2450 MPa, 2500 MPa, 2550 MPa, 2600 MPa, 2650 MPa, 2700 MPa, 2750 MPa, 2800 MPa, 2850 MPa, 2900 MPa, 2950 MPa, and 3000 MPa, as measured by ASTM D638. Tensile strength at yield of the PBT can be from 20 MPa to 60 MPa, or at least, equal to, and/or between any two of 20 MPa, 25 MPa, 30 MPa, 35 MPa, 40 MPa, 45 MPa, 50 MPa, 55 MPa, and 60 MPa, as measured by ISO 527.

The Izod notched impact strength of the PBT component at −30° C. can be from 2 kJ/m² to 8 kJ/m² or at least, equal to, and/or between any two of 3 kJ/m², 4 KJ/m², 5 kJ/m², and 6 kJ/m², 7 kJ/m², and 8 kJ/m². The Izod notched impact strength of the PBT component at 23° C. can be from 4 kJ/m² to 15 kJ/m² or at least, equal to, and/or between any two of 4 kJ/m², 5 kJ/m², 6 kJ/m², 7 kJ/m², 8 kJ/m², 9 kJ/m², 10 kJ/m², 11 kJ/m², 12 kJ/m², 13 kJ/m², 14 kJ/m², and 15 kJ/m² 22 kJ/m², as measured by ISO 180.

The PBT component, as described above, is used as a polymer blend in combination with one or more different primary additives for use in the high-frequency radio wave applications. These primary additives are those that may impart a lower Dk, a lower Df, higher metal adhesion strength, and a low CTE for the PBT composition as compared to the PBT without such additives. The PBT composition may also exhibit high mechanical strength and good thermal performance.

The primary additives include hollow glass bubbles. Such glass bubbles help reduce the bulk density of the PBT, as well as lower the Dk and Df values. This is due, at least in part, to the lower Dk and Df values of the glass bubbles themselves because of the presence of air, gas or vacuum space within the glass bubbles.

The glass bubbles are typically hollow, thin-walled unicellular spheres made from soda-lime borosilicate glass. The glass bubbles may have an average diameter or particle size of from 5 μm to 80 μm, more particularly an average diameter or particle size of from 15 μm to 65 μm. In particular embodiments, the glass bubbles may have an average diameter or particle size of at least, equal to, and/or between any two of 5 μm, 6 μm, 7 μm, 8 μm, 9 μm, 10 μm, 11 μm, 12 μm, 13 μm, 14 μm, 15 μm, 16 μm, 17 μm, 18 μm, 19 μm, and 20 μm, 21 μm, 22 μm, 23 μm, 24 μm, 25 μm, 26 μm, 27 μm, 28 μm, 29 μm, 30 μm, 31 μm, 32 μm, 33 μm, 34 μm, 35 μm, 36 μm, 37 μm, 38 μm, 39 μm, 40 μm, 41 pm, 42 μm, 43 μm, 44 μm, 45 μm, 46 μm, 47 μm, 48 μm, 49 μm, 50 μm, 51 μm, 52 μm, 53 μm, 54 μm, 55 μm, 56 μm, 57 μm, 58 μm, 59 μm, 60 μm, 61 μm, 62 μm, 63 μm, 64 μm, 65 μm, 66 μm, 67 μm, 68 μm, 69 μm, 70 μm, 71 μm, 72 μm, 73 μm, 74 μm, 75 μm, 76 μm, 77 μm, 78 μm, 79 μm, and 80 μm.

The hollow glass bubbles may have a wall thickness of from 0.4 μm to 1.5 μm, more particularly from 0.5 μm to 0.9 μm, and still more particularly from 0.6 μm to 0.8 μm. In particular embodiments, the glass bubbles may have wall thickness of at least, equal to, and/or between any two of 0.40 μm, 0.41 μm, 0.42 μm, 0.43 μm, 0.44 μm, 0.45 μm, 0.46 μm, 0.47 μm, 0.48 μm, 0.49 μm, 0.50 μm, 0.51 μm, 0.52 μm, 0.53 μm, 0.54 μm, 0.55 μm, 0.56 μm, 0.57 μm, 0.58 μm, 0.59 pm, 0.60 μm, 0.61 μm, 0.62 μm, 0.63 μm, 0.64 μm, 0.65 μm, 0.66 μm, 0.67 μm, 0.68 μm, 0.69 μm, 0.70 μm, 0.71 μm, 0.72 μm, 0.73 μm, 0.74 μm, 0.75 μm, 0.76 μm, 0.77 μm, 0.78 μm, 0.79 μm, 0.80 μm, 0.81 μm, 0.82 μm, 0.83 μm, 0.84 μm, 0.85 μm, 0.86 μm, 0.87 μm, 0.88 μm, 0.89 μm, 0.90 μm, 0.91 μm, 0.92 μm, 0.93 μm, 0.94 μm, 0.95 μm, 0.96 μm, 0.97 μm, 0.98 μm, 0.99 μm, 1.00 μm, 1.11 μm, 1.12 μm, 1.13 μm, 1.14 μm, 1.15 μm, 1.16 μm, 1.17 μm, 1.18 μm, 1.19 μm, 1.20 μm, 1.21 μm, 1.22 μm, 1.23 μm, 1.24 μm, 1.25 μm, 1.26 μm, 1.27 μm, 1.28 μm, 1.29 μm, 1.30 μm, 1.31 μm, 1.32 μm, 1.33 μm, 1.34 μm, 1.35 μm, 1.36 μm, 1.37 μm, 1.38 μm, 1.39 μm, 1.40 μm, 1.41 μm, 1.42 μm, 1.43 μm, 1.44 μm, 1.45 μm, 1.46 μm, 1.47 μm, 1.48 μm, 1.49 μm, and 1.50 μm.

This may provide a gas volume or interior space within the hollow glass sphere of from 50% to approximately 90%. Those glass bubbles having a gas volume or interior space of from 60% to 80% have been found to be particularly useful. In particular embodiments, gas volume or interior space within the hollow glass bubble may be at least, equal to, and/or between any two of 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88%, 89%, and 90%. The interior space of the glass bubbles is typically filled with air, but may also be filled with other gases, such as nitrogen. The interior space may also be without any medium (vacuum) or filled with low dielectric liquids that facilitate lowering of the Dk and Df values.

The glass bubbles may have a true density of 0.3 g/cc to 0.8 g/cc, as measured by helium pycnometry. In particular embodiments, the glass bubbles may have a true density of at least, equal to, and/or between any two of 0.30 g/cc, 0.31 g/cc, 0.32 g/cc, 0.33 g/cc, 0.34 g/cc, 0.35 g/cc, 0.36 g/cc, 0.37 g/cc, 0.38 g/cc, 0.39 g/cc, 0.40 g/cc, 0.41 g/cc, 0.42 g/cc, 0.43 g/cc, 0.44 g/cc, 0.45 g/cc, 0.46 g/cc, 0.47 g/cc, 0.48 g/cc, 0.49 g/cc, 0.50 g/cc, 0.51 g/cc, 0.52 g/cc, 0.53 g/cc, 0.54 g/cc, 0.55 g/cc, 0.56 g/cc, 0.57 g/cc, 0.58 g/cc, 0.59 g/cc, 0.60 g/cc, 0.61 g/cc, 0.62 g/cc, 0.63 g/cc, 0.64 g/cc, 0.65 g/cc, 0.66 g/cc, 0.67 g/cc, 0.68 g/cc, 0.69 g/cc, 0.70 g/cc, 0.71 g/cc, 0.72 g/cc, 0.73 g/cc, 0.74 g/cc, 0.75 g/cc, 0.76 g/cc, 0.77 g/cc, 0.78 g/cc, 0.79 g/cc, 0.80 g/cc, as measured by helium pycnometry.

Furthermore, the hollow glass bubbles may have a crush strength of from 30 MPa to 300 MPa. In particular embodiments, the glass bubbles may have a crush strength of at least, equal to, and/or between any two of 30 MPa, 31 MPa, 32 MPa, 33 MPa, 34 MPa, 35 MPa, 36 MPa, 37 MPa, 38 MPa, 39 MPa, 40 MPa, 41 MPa, 42 MPa, 43 MPa, 44 MPa, 45 MPa, 46 MPa, 47 MPa, 48 MPa, 49 MPa, 50 MPa, 51 MPa, 52 MPa, 53 MPa, 54 MPa, 55 MPa, 56 MPa, 57 MPa, 58 MPa, 59 MPa, 65 MPa, 66 MPa, 67 MPa, 68 MPa, 69 MPa, 70 MPa, 71 MPa, 72 MPa, 73 MPa, 74 MPa, 75 MPa, 76 MPa, 77 MPa, 78 MPa, 79 MPa, 80 MPa, 81 MPa, 82 MPa, 83 MPa, 84 MPa, 85 MPa, 86 MPa, 87 MPa, 88 MPa, 89 MPa, 90 MPa, 91 MPa, 92 MPa, 93 MPa, 94 MPa, 95 MPa, 96 MPa, 97 MPa, 98 MPa, 99 MPa, 100 MPa, 105 MPa, 110 MPa, 115 MPa, 120 MPa, 125 MPa, 130 MPa, 135 MPa, 140 MPa, 145 MPa, 150 MPa, 155 MPa, 160 MPa, 165 MPa, 170 MPa, 175 MPa, 180 MPa, 185 MPa, 190 MPa, 195 MPa, 200 MPa, 205 MPa, 210 MPa, 215 MPa, 220 MPa, 225 MPa, 230 MPa, 235 MPa, 240 MPa, 245 MPa, 250 MPa, 255 MPa, 260 MPa, 265 MPa, 270 MPa, 275 MPa, 280 MPa, 285 MPa, 290 MPa, 295 MPa, and 300 MPa.

Examples of suitable commercially available hollow glass bubbles are those available as iM16K and iM30K glass bubbles, from 3M Company, Maplewood, Minnesota. Glass bubble (IM30K Hi-Strength Glass Bubbles) used in the present work is commercially procured from 3M™. The crush strength and the gas volume of the hollow glass bubble were measured by 3M's internal QCM.

The hollow glass bubbles may be used in the PBT composition in an amount of from 1 wt % to 35 wt % by total weight of the PBT composition. In particular embodiments, the glass bubbles may be used in an amount of at least, equal to, and/or between any two of 1 wt %, 2 wt %, 3 wt %, 4 wt %, 5 wt %, 6 wt %, 7 wt %, 8 wt %, 9 wt %, 10 wt %, 11 wt %, 12 wt %, 13 wt %, 14 wt %, 15 wt %, 16 wt %, 17 wt %, 18 wt %, 19 wt %, 20 wt %, 21 wt %, 22 wt %, 23 wt %, 24 wt %, 25 wt %, 26 wt %, 27 wt %, 29 wt %, 30 wt %, 31 wt %, 32 wt %, 33 wt %, 34 wt %, and 35 wt % by total weight of the PBT composition.

It may be expected that a certain amount of breakage of the glass bubbles will occur during the melt blending of the polymer composition. This may typically result in from 5% or less of the glass bubbles being broken. While breakage of the glass bubbles should be minimized, such broken glass bubbles essentially become glass powder, which can facilitate reinforcement of the PBT composition.

Because the glass bubbles and/or broken glass bubbles in themselves do not provide sufficient reinforcement of the PBT composition, other materials may also be used in the PBT composition. These include short glass fibers (SGF) materials and aluminum oxide fiber materials.

The glass fibers can be used to enhance both the mechanical and thermal properties of the PBT composition. This includes higher stiffness, higher tensile or flexural modulus, a lower CTE, a higher heat deflection temperature (HDT), and better dimensional stability. The short glass fibers can also include those glass fibers having low Dk and/or Df values so that the enhanced properties provided to the polymer composition of low Dk and Df provided by the glass bubbles are enhanced or not significantly reduced or altered.

The short glass fibers may have a length of from 0.5 mm to 10 mm and a width or diameter of from 5 μm to 15 μm. In particular applications, the short glass fibers may have a length of at least, equal to, and/or between any two of 0.5 mm, 0.6 mm, 0.7 mm, 0.8 mm, 0.9 mm, 1.0 mm, 1.1 mm, 1.2 mm, 1.3 mm, 1.4 mm, 1.5 mm, 1.6 mm, 1.7 mm, 1.8 mm, 1.9 mm, 2.0 mm, 2.1 mm, 2.2 mm, 2.3 mm, 2.4 mm, 2.5 mm, 2.6 mm, 2.7 mm, 2.8 mm, 2.9 mm, 3.0 mm, 3.1 mm, 3.2 mm, 3.3 mm, 3.4 mm, 3.5 mm, 3.6 mm, 3.7 mm, 3.8 mm, 3.9 mm, 4.0 mm, 4.1 mm, 4.2 mm, 4.3 mm, 4.4 mm, 4.5 mm, 4.6 mm, 4.7 mm, 4.8 mm, 4.9 mm, 5.0 mm, 5.1 mm, 5.2 mm, 5.3 mm, 5.4 mm, 5.5 mm, 5.6 mm, 5.7 mm, 5.8 mm, 5.9 mm, 6.0 mm, 6.1 mm, 6.2 mm, 6.3 mm, 6.4 mm, 6.5 mm, 6.6 mm, 6.7 mm, 6.8 mm, 6.9 mm, and 7.0 mm, 7.1 mm, 7.2 mm, 7.3 mm, 7.4 mm, 7.5 mm, 7.6 mm, 7.7 mm, 7.8 mm, 7.9 mm, 8.0 mm, 8.1 mm, 8.2 mm, 8.3 mm, 8.4 mm, 8.5 mm, 8.6 mm, 8.7 mm, 8.8 mm, 8.9 mm, 9.0 mm, 9.1 mm, 9.2 mm, 9.3 mm, 9.4 mm, 9.5 mm, 9.6 mm, 9.7 mm, 9.8 mm, 9.9 mm, and 10.0 mm. The short glass fibers may have a width or diameter of at least, equal to, and/or between any two of 5 μm, 6 μm, 7 μm, 8 μm, 9 μm, 10 μm, 11 μm, 12 μm, 13 μm, 14 μm, and 15 μm.

The short glass fibers may be used in the PBT composition in an amount of 40 wt % or less by total weight of the PBT composition, with from 1 wt % to 30 wt % by total weight of the PBT composition being suitable in many instances. In particular embodiments, the glass fibers may be used in an amount of at least, equal to, and/or between any two of 0.1 wt %, 0.2 wt %, 0.3 wt %, 0.4 wt %, 0.5 wt %, 0.6 wt %, 0.7 wt %, 0.8 wt %, 0.9 wt %, 1 wt %, 2 wt %, 3 wt %, 4 wt %, 5 wt %, 6 wt %, 7 wt %, 8 wt %, 9 wt %, 10 wt %, 11 wt %, 12 wt %, 13 wt %, 14 wt %, 15 wt %, 16 wt %, 17 wt %, 18 wt %, 19 wt %, 20 wt %, 21 wt %, 22 wt %, 23 wt %, 24 wt %, 25 wt %, 26 wt %, 27 wt %, 29 wt %, 30 wt %, 31 wt %, 32 wt %, 33 wt %, 34 wt %, 35 wt %, 36 wt %, 37 wt %, 38 wt %, 39 wt %, and 40 wt % by total weight of the PBT composition.

The PBT compositions incorporating short glass fibers may have a CTE of 35×10⁻⁶/° C. or less, as measured according to ASTM D696. In certain embodiments, the CTE value of PBT compositions incorporating the short glass fibers may be 35, 30, 25, 20, 15, 10, 9, 8, 7, 6, 5, 4, 3, 2, 1, or 0.5×10⁻⁶/° C. or less, as measured according to ASTM D696.

In certain applications, the short glass fibers may be those having higher or lower Dk and Df values, as both the low and high Dk and Df value glass fibers will offer similar reinforcing effects to the PBT composition. If used, the short glass fibers with higher Dk and Df values may be those having a Dk value of 5 or greater, as measured according to ASTM D150 at 6 MHz or higher, and a dissipation factor Dk of greater than 0.005, as measured according to ASTM D150 at 6 MHz or higher. Such glass fibers may include E-CR (E-Glass corrosion resistant) glass fibers. An example of such commercially available short glass fibers are those available as DS2200 13P glass fibers, from Braj Binani Group, Mumbai, India. These glass fibers are distinguished from those glass fibers having low Dk and Df values. These glass fibers are distinguished from those glass fibers having low Dk and Df values.

Glass fibers having low dielectric or Dk and Df values may also be used alone or in combination with those short glass fibers having higher Dk and Df values. The low Dk glass fibers may be those having a Dk value of from 4 to 5, as measured according to ASTM D150 at 6 MHz or higher. In certain embodiments, the low Dk glass fibers may have a Dk value of at least, equal to, and/or between any two of 4.0, 4.1, 4.2, 4.3, 4.4, 4.5, 4.6, 4.7, 4.8, 4.9, and 5.0. The low Df glass fibers may be those having a Df value of 0.005, 0.004, 0.003, 0.002, 0.001, 0.0009, 0.0008, 0.0007, 0.0006, 0.0005, 0.0004, 0.0003, 0.0002, 0.0001, or less. The low Dk and Df glass fibers may have one or both low Dk and low Df. Typically, the low Dk and Df fibers will have both low Dk and low Df. Such glass fibers may include HL-glass fibers. An example of such commercially available short glass fiber having low Dk and Df values are those available as CS(HL)303N-3 glass fibers, from Chongqing Polycomp International Corp, Chongqing, China.

The low Dk and low Df glass fibers may make up all or a portion of the total short glass fibers. The low Dk and low Df glass fibers may be present in the PBT composition in an amount of 40 wt % or less by total weight of the PBT composition. In particular embodiments, if used, the low Dk and low Df glass fibers may be used in an amount of at least, equal to, and/or between any two of 0.1 wt %, 0.2 wt %, 0.3 wt %, 0.4 wt %, 0.5 wt %, 0.6 wt %, 0.7 wt %, 0.8 wt %, 0.9 wt %, 1 wt %, 2 wt %, 3 wt %, 4 wt %, 5 wt %, 6 wt %, 7 wt %, 8 wt %, 9 wt %, 10 wt %, 11 wt %, 12 wt %, 13 wt %, 14 wt %, 15 wt %, 16 wt %, 17 wt %, 18 wt %, 19 wt %, 20 wt %, 21 wt %, 22 wt %, 23 wt %, 24 wt %, 25 wt %, 26 wt %, 27 wt %, 29 wt %, 30 wt %, 31 wt %, 32 wt %, 33 wt %, 34 wt %, 35 wt %, 36 wt %, 37 wt %, 38 wt %, 39 wt %, and 40 wt % by total weight of the PBT composition.

Aluminum oxide fibers may be used in the PBT composition. Aluminum oxide fibers enhance the mechanical properties, such as tensile modulus and stiffness, while remaining radio frequency (RF) transparent. The aluminum oxide fibers may be of any form of aluminum oxide phase and may be obtained using any suitable process. The aluminum oxide fibers can be of a generally cylindrical shape and/or of a flat shape. The length of the aluminum oxide fibers may be in the range of 1 mm to 10 mm length and the diameter or width may be in the range of 1 μm to 15 μm. In particular applications, the aluminum oxide fibers may have a length of at least, equal to, and/or between any two of 1.0 mm, 1.1 mm, 1.2 mm, 1.3 mm, 1.4 mm, 1.5 mm, 1.6 mm, 1.7 mm, 1.8 mm, 1.9 mm, 2.0 mm, 2.1 mm, 2.2 mm, 2.3 mm, 2.4 mm, 2.5 mm, 2.6 mm, 2.7 mm, 2.8 mm, 2.9 mm, 3.0 mm, 3.1 mm, 3.2 mm, 3.3 mm, 3.4 mm, 3.5 mm, 3.6 mm, 3.7 mm, 3.8 mm, 3.9 mm, 4.0 mm, 4.1 mm, 4.2 mm, 4.3 mm, 4.4 mm, 4.5 mm, 4.6 mm, 4.7 mm, 4.8 mm, 4.9 mm, 5.0 mm, 5.1 mm, 5.2 mm, 5.3 mm, 5.4 mm, 5.5 mm, 5.6 mm, 5.7 mm, 5.8 mm, 5.9 mm, 6.0 mm, 6.1 mm, 6.2 mm, 6.3 mm, 6.4 mm, 6.5 mm, 6.6 mm, 6.7 mm, 6.8 mm, 6.9 mm, and 7.0 mm, 7.1 mm, 7.2 mm, 7.3 mm, 7.4 mm, 7.5 mm, 7.6 mm, 7.7 mm, 7.8 mm, 7.9 mm, 8.0 mm, 8.1 mm, 8.2 mm, 8.3 mm, 8.4 mm, 8.5 mm, 8.6 mm, 8.7 mm, 8.8 mm, 8.9 mm, 9.0 mm, 9.1 mm, 9.2 mm, 9.3 mm, 9.4 mm, 9.5 mm, 9.6 mm, 9.7 mm, 9.8 mm, 9.9 mm, and 10.0 mm. The aluminum oxide fibers may have a width or diameter of at least, equal to, and/or between any two of 1 μm, 2 μm, 3 μm, 4 μm, 5 μm, 6 μm, 7 μm, 8 μm, 9 μm, 10 μm, 11 μm, 12 μm, 13 μm, 14 μm, and 15 μm. An example of such commercially available aluminum oxide fibers are those available as Nextel 610 fibers, from 3M Company, Maplewood, Minnesota.

The aluminum oxide fibers may be present in the PBT composition in an amount of 40 wt % or less by total weight of the PBT composition. If used, in particular embodiments, the aluminum oxide fibers may be used in an amount of at least, equal to, and/or between any two of 0.1 wt %, 0.2 wt %, 0.3 wt %, 0.4 wt %, 0.5 wt %, 0.6 wt %, 0.7 wt %, 0.8 wt %, 0.9 wt %, 1 wt %, 2 wt %, 3 wt %, 4 wt %, 5 wt %, 6 wt %, 7 wt %, 8 wt %, 9 wt %, 10 wt %, 11 wt %, 12 wt %, 13 wt %, 14 wt %, 15 wt %, 16 wt %, 17 wt %, 18 wt %, 19 wt %, 20 wt %, 21 wt %, 22 wt %, 23 wt %, 24 wt %, 25 wt %, 26 wt %, 27 wt %, 29 wt %, 30 wt %, 31 wt %, 32 wt %, 33 wt %, 34 wt %, 35 wt %, 36 wt %, 37 wt %, 38 wt %, 39 wt %, and 40 wt % by total weight of the PBT composition.

In certain applications, polyethylene terephthalate (PET) is used with the PBT. The PET used can be characterized by its intrinsic viscosity in the range of 0.5 dl/g to 0.8 dl/g and a bulk density in the range of 800 kg/m³ to 850 kg/m³ as per ASTM D1895. If used, the amount of any PET component is present in in an amount of 30 wt % or less by total weight of the composition. In particular embodiments, if used, the PET may be used in an amount of at least, equal to, and/or between any two of 0.1 wt %, 0.2 wt %, 0.3 wt %, 0.4 wt %, 0.5 wt %, 0.6 wt %, 0.7 wt %, 0.8 wt %, 0.9 wt %, 1 wt %, 2 wt %, 3 wt %, 4 wt %, 5 wt %, 6 wt %, 7 wt %, 8 wt %, 9 wt %, 10 wt %, 11 wt %, 12 wt %, 13 wt %, 14 wt %, 15 wt %, 16 wt %, 17 wt %, 18 wt %, 19 wt %, 20 wt %, 21 wt %, 22 wt %, 23 wt %, 24 wt %, 25 wt %, 26 wt %, 27 wt %, 29 wt %, and 30 wt % by total weight of the PBT composition. An example of such commercially available PET are those available as BC210, BC211, BC212, PCG 60 and PCG 80, available from Saudi Basic Industries Corporation, Riyadh, Saudi Arabia. In certain applications, no PET is used in the PBT composition.

Polycarbonate can also be used in the PBT composition. The weight average molecular weight of polycarbonates, as inferred by gel permeation chromatography, is in the range of 30,000 to 60,000, as per polystyrene standards. Polycarbonates are fully end-capped, as inferred from NMR analyses. Polycarbonates can improve the metal adhesion and lower the warpage. Such polycarbonates include, but are not limited to, bisphenol-A polycarbonate and copolycarbonates obtained with the varying proportions (e.g., 20% to 50%) of different comonomers. Particularly useful is bisphenol-A polycarbonate.

Polycarbonates may be used in an amount of 30 wt % or less by total weight of the PBT composition, both with and without a transesterification catalyst. If used, in particular embodiments, the polycarbonates may be used in an amount of at least, equal to, and/or between any two of 0.1 wt %, 0.2 wt %, 0.3 wt %, 0.4 wt %, 0.5 wt %, 0.6 wt %, 0.7 wt %, 0.8 wt %, 0.9 wt %, 1 wt %, 2 wt %, 3 wt %, 4 wt %, 5 wt %, 6 wt %, 7 wt %, 8 wt %, 9 wt %, 10 wt %, 11 wt %, 12 wt %, 13 wt %, 14 wt %, 15 wt %, 16 wt %, 17 wt %, 18 wt %, 19 wt %, 20 wt %, 21 wt %, 22 wt %, 23 wt %, 24 wt %, 25 wt %, 26 wt %, 27 wt %, 28 wt %, 29 wt %, and 30 wt % by total weight of the PBT composition.

The PBT compositions or polymer blend formed during melt blending can further include at least one additional secondary additive, as distinguished from those primary additives discussed above. Such optional or secondary additives may be those that do not necessarily impact or increase the dielectric (i.e., Dk and Df values), mechanical or thermal properties of final product, although they may. These may be added to facilitate processing during the melt blending and extrusion process but may also impart various desired properties to the final PBT composition. Non-limiting examples of additional optional or secondary additives include stabilizing agent, a coupling agent, a compatibilizing agent, a heat conductive agent, a fire retardant additive, a thermally conductive additive, a tie agent, an antiblocking agent, an antistatic agent, an antioxidant, a neutralizing agent, an acid scavenger, a blowing agent, a nucleating agent, a crystallization aid, a dye, a flame retardant agent, a filler, a hard filler, a soft filler, an impact modifier, a mold release agent, an oil, another polymer, a pigment, a processing agent, a reinforcing agent, a light stabilizer, a UV resistance agent, a slip agent, a flow modifying agent, and combinations thereof, and combinations thereof.

Because the PBT has polar functional groups throughout the polymer chain, this may facilitate dispersion of the glass bubbles, glass fibers, polycarbonate, etc., throughout the polymer blend. Thus, the use of a coupling agent in the polymer blend to achieve a good interface with the glass bubbles and fibers may be reduced or eliminated. In certain embodiments, however, a coupling agent may be used within the PBT component or glass fibers. Glass fibers can be treated with silane coupling agents to further enhance the uniform dispersion of these materials within the PBT matrix. The coupling agent may be a maleic anhydride grafted PBT (MA-g-PP). The coupling occurs in situ in the extruder. With the use of this coupling agent, the interaction between the maleic anhydride group and amino group on amino-silane treated glass fibers facilitates their dispersion. An example of a suitable coupling agent for PBT is that maleic anhydride grafted polypropylene (MA-g-PP) available as EXELOR P1020, from Exxon Mobil. The coupling agent may be present in the polymer blend in amount of from 2 wt % or less by total weight of the polymer blend. In particular embodiments, if used, the coupling agent may be used in an amount of at least, equal to, and/or between any two of 0.01 wt %, 0.2 wt %, 0.3 wt %, 0.4 wt %, 0.5 wt %, 0.6 wt %, 0.7 wt %, 0.8 wt %, 0.9 wt %, 1.0 wt %, 1.1 wt %, 1.2 wt %, 1.3 wt %, 1.4 wt %, 1.5 wt %, 1.6 wt %, 1.7 wt %, 1.8 wt %, 1.9 wt %, and 2.0 wt % by total weight of the polymer blend. When polycarbonate is incorporated into PBT, a transesterification catalyst, such as p-toluene sulfonic acid, may be added to enable reactive coupling between PBT and polycarbonate. The amount of transesterification catalyst may range from 0.001 wt % to 0.01 wt % by total weight of the polymer blend.

In some instances, a heat conductive additive is present in the polymer blend in an amount of at least, equal to, and/or between any two of 0.01 wt %, 0.2 wt %, 0.3 wt %, 0.4 wt %, 0.5 wt %, 0.6 wt %, 0.7 wt %, 0.8 wt %, 0.9 wt %, and 1.0 wt % by total weight of the polymer blend. Non-limiting examples of heat conductive additive include, aluminum oxide, titanium dioxide, graphitic compounds, graphenes, boron nitride, aluminum nitride, zinc oxide.

In some embodiments, a filler is present in the polymer blend in amount of at least, equal to, and/or between any two of 0.01 wt %, 0.2 wt %, 0.3 wt %, 0.4 wt %, 0.5 wt %, 0.6 wt %, 0.7 wt %, 0.8 wt %, 0.9 wt %, 1.0 wt %, 2.0 wt %, 3.0 wt %, 4.0 wt %, 5.0 wt %, 6.0 wt %, 7.0 wt %, 8.0 wt %, 9.0 wt %, 10.0 wt %, 20.0 wt %, 30.0 wt % by total weight of the polymer blend. The filler can be a hard filler. Non-limiting examples of hard filler include inorganic particulate fillers such as talc, silica, calcium carbonate, inorganic layered fillers such as clays, mica. The filler can be a soft filler. Non-limiting examples of soft filler include immiscible particulate elastomeric/polymeric resins. The filler can also be a hollow filler. Non-limiting examples of hollow filler include, plastic microspheres, ceramic microspheres such as cenospheres made up of alumino silicate microspheres, metallic microspheres made up of aluminum and copper/silver microspheres, and phenolic microspheres.

In certain aspects, a light stabilizer is present in the polymer blend in an amount of at least, equal to, and/or between any two of 0.01 wt %, 0.2 wt %, 0.3 wt %, 0.4 wt %, 0.5 wt %, 0.6 wt %, 0.7 wt %, 0.8 wt %, 0.9 wt %, and 1.0 wt % by total weight of the polymer blend. The light stabilizer can be a hindered amine light stabilizer. The term “hindered amine light stabilizer” refers to a class of amine compounds having certain light stabilizing properties. Non-limiting examples, of hindered amine light stabilizers (HALS) include 1-cyclohexyloxy-2,2,6,6-tetramethyl-4-octadecylaminopiperidine; bis(2,2,6,6-tetramethylpiperidin-4-yl) sebacate; bis(1-acetoxy-2,2,6,6-tetramethylpiperidin-4-yl) sebacate; bis(1,2,2,6,6-pentamethylpiperidin-4-yl) sebacate; bis(1-cyclohexyloxy-2,2,6,6-tetramethylpiperidin-4-yl) sebacate; bis(1-octyloxy-2,2,6,6-tetramethylpiperidin-4-yl) sebacate; bis(1-acyl-2,2,6,6-tetramethylpiperidin-4-yl) sebacate; bis(1,2,2,6,6-pentamethyl-4-piperidyl) n-butyl-3,5-di-tert-butyl-4-hydroxybenzyl malonate; 2,4-bis[(1-cyclohexyloxy-2,2,6,6-tetramethylpiperidin-4-yl)butylamino]-6-(2-hydroxyethyl amino-s-triazine; bis(1-cyclohexyloxy-2,2,6,6-tetramethylpiperidin-4-yl) adipate; 2,4-bis[(1-cyclohexyloxy-2,2,6,6-piperidin-4-yl)butylamino]-6-chloro-s-triazine; 1-(2-hydroxy-2-methylpropoxy)-4-hydroxy-2,2,6,6-tetramethylpiperidine; 1-(2-hydroxy-2-methylpropoxy)-4-oxo-2,2,6,6-tetramethylpiperidine; 1-(2-hydroxy-2-methyl propoxy)-4-octadecanoyloxy-2,2,6,6-tetramethyl piperidine; bis(1-(2-hydroxy-2-methylpropoxy)-2,2,6,6-tetramethylpiperidin-4-yl) sebacate; bis(1-(2-hydroxy-2-methylpropoxy)-2,2,6,6-tetramethylpiperidin-4-yl) adipate; 2,4-bis{N-[1-(2-hydroxy-2-methyl propoxy)-2,2,6,6-tetramethylpiperidin-4-yl]-N-butylamino}-6-(2-hydroxyethylamino)-s-triazine; 4-benzoyl-2,2,6,6-tetramethylpiperidine; di-(1,2,2,6,6-pentamethylpiperidin-4-yl) p-methoxybenzylidenemalonate; 2,2,6,6-tetramethylpiperidin-4-yl octadecanoate; bis(1-octyloxy-2,2,6,6-tetramethylpiperidyl) succinate; 1,2,2,6,6-pentamethyl-4-aminopiperidine; 2-undecyl-7,7,9,9-tetramethyl-1-oxa-3,8-diaza-4-oxo-spiro[4,5]decane; tris(2,2,6,6-tetramethyl-4-piperidyl) nitrilotriacetate; tris(2-hydroxy-3-(amino-(2,2,6,6-tetramethylpiperidin-4-yl)propyl) nitrilotriacetate; tetrakis(2,2,6,6-tetramethyl-4-piperidyl)-1,2,3,4-butane-tetracarboxylate; tetrakis(1,2,2,6,6-pentamethyl-4-piperidyl)-1,2,3,4-butane-tetracarboxylate; 1,1′-(1,2-ethanediyl)-bis(3,3,5,5-tetramethylpiperazinone); 3-n-octyl-7,7,9,9-tetramethyl-1,3,8-triazaspiro[4.5]decan-2,4-dione; 8-acetyl-3-dodecyl-7,7,9,9-tetramethyl-1,3,8-triazaspiro[4.5]decane-2,4-dione; 3-dodecyl-1-(2,2,6,6-tetramethyl-4-piperidyl)pyrrolidin-2,5-dione; 3-dodecyl-1-(1,2,2,6,6-pentamethyl-4-piperidyl)pyrrolidine-2,5-dione; N,N′-bis-formyl-N,N′-bis(2,2,6,6-tetramethyl-4-piperidyl)hexamethylenediamine; reaction product of 2,4-bis[(1-cyclohexyloxy-2,2,6,6-piperidin-4-yl)butylamino]-6-chloro-s-triazine with N,N′-bis(3-aminopropyl)ethylenediamine); condensate of 1-(2-hydroxyethyl)-2,2,6,6-tetramethyl-4-hydroxypiperidine and succinic acid; condensate of N,N′-bis(2,2,6,6-tetramethyl-4-piperidyl)-hexamethylenediamine and 4-tert-octylamino-2,6-dichloro-1,3,5-triazine; condensate of N,N′-bis(2,2,6,6-tetramethyl-4-piperidyl)-hexamethylenediamine and 4-cyclohexylamino-2,6-dichloro-1,3,5-triazine; condensate of N,N′-bis-(2,2,6,6-tetramethyl-4-piperidyl)hexamethylenediamine and 4-morpholino-2,6-dichloro-1,3,5-triazine; condensate of N,N′-bis-(1,2,2,6,6-pentamethyl-4-piperidyl)hexamethylenediamine and 4-morpholino-2,6-dichloro-1,3,5-triazine; condensate of 2-chloro-4,6-bis(4-n-butylamino-2,2,6,6-tetramethyl piperidyl)-1,3,5-triazine and 1,2-bis(3-aminopropylamino)ethane; condensate of 2-chloro-4,6-di-(4-n-butylamino-1,2,2,6,6-pentamethylpiperidyl)-1,3,5-triazine and 1,2-bis-(3-aminopropylamino)ethane; a reaction product of 7,7,9,9-tetramethyl-2-cycloundecyl-1-oxa-3,8-diaza-4-oxospiro[4,5]decane and epichlorohydrin; poly[methyl, (3-oxy-(2,2,6,6-tetramethylpiperidin-4-yl)propyl)]siloxane, CAS #182635-99-0; reaction product of maleic acid anhydride-C18-C22-α-olefin-copolymer with 2,2,6,6-tetramethyl-4-aminopiperidine; oligomeric condensate of 4,4′-hexamethylenebis(amino-2,2,6,6-tetramethylpiperidine) and 2,4-dichloro-6-[(2,2,6,6-tetramethylpiperidin-4-yl)butylamino]-s-triazine end-capped with 2-chloro-4,6-bis(dibutylamino)-s-triazine; oligomeric condensate of 4,4′-hexamethylenebis(amino-1,2,2,6,6-pentaamethylpiperidine) and 2,4-dichloro-6-[(1,2,2,6,6-pentaamethylpiperidin-4-yl)butylamino]-s-triazine end-capped with 2-chloro-4,6-bis(dibutylamino)-s-triazine; oligomeric condensate of 4,4′-hexamethylenebis(amino-1-propoxy-2,2,6,6-tetramethyl piperidine) and 2,4-dichloro-6-[(1-propoxy-2,2,6,6-tetramethylpiperidin-4-yl)butylamino]-s-triazine end-capped with 2-chloro-4,6-bis(dibutylamino)-s-triazine; oligomeric condensate of 4,4′-hexamethylenebis(amino-1-acyloxy-2,2,6,6-tetramethyl piperidine) and 2,4-dichloro-6-[(1-acyloxy-2,2,6,6-tetramethylpiperidin-4-yl)butylamino]-s-triazine end-capped with 2-chloro-4,6-bis(dibutylamino)-s-triazine; and product obtained by reacting (a) with (b) where (a) is product obtained by reacting 1,2-bis(3-aminopropylamino)ethane with cyanuric chloride and (b) is (2,2,6,6-tetramethyl piperidin-4-yl)butylamine. Also included are the sterically hindered N—H, N-methyl, N-methoxy, N-hydroxy, N-propoxy, N-octyloxy, N-cyclohexyloxy, N-acyloxy and N-(2-hydroxy-2-methylpropoxy) analogues of any of the above-mentioned compounds. Non-limiting examples of commercial light stabilizer are available from BASF under the trade name Uvinul® 4050H, 4077H, 4092H, 5062H, 5050H, 4092H, 4077H, 3026, 3027, 3028, 3029, 3033P, and 3034 or Tinuvin® 622.

Anti-static agents can be used to inhibit accumulation of dust on plastic articles. Antistatic agents can improve the electrical conductivity of the plastic compositions, and thus dissipate any surface charges, which develop during production and use. Thus, dust particles are less attracted to the surface of the plastic article, and dust accumulation is consequently reduced. In certain aspects of the present invention, the antistatic agent can be a glycerol monostearate. The polymer blend can include an anti-static agent in an amount of at least, equal to, and/or between any two 0.01 wt %, 0.2 wt %, 0.3 wt %, 0.4 wt %, 0.5 wt %, 0.6 wt %, 0.7 wt %, 0.8 wt %, 0.9 wt %, and 1 wt % by total weight of the polymer blend.

A lubricant can be added to a polymer blend to improve the mold-making characteristics. The lubricant can be a low molecular compound from a group of fatty acids, fatty acid esters, wax ester, fatty alcohol ester, amide waxes, metal carboxylate, montanic acids, montanic acid ester, or such high molecular compounds, as paraffins or polyethylene waxes. In certain aspects of the present invention, the lubricant is a metal stearate. Non-limiting examples of metal stearates include zinc stearate, calcium stearate, lithium stearate or a combination thereof, preferably calcium stearate. The polymer blend can include a lubricant in an amount of at least, equal to, and/or between any two of 0.01 wt %, 0.2 wt %, 0.3 wt %, 0.4 wt %, 0.5 wt %, 0.6 wt %, 0.7 wt %, 0.8 wt %, 0.9 wt %, and 1 wt % by total weight of the polymer blend.

An antioxidant and/or heat stabilizer can provide protection against polymer degradation during processing. Phosphites are known thermal oxidative stabilizing agents for polymers and other organic materials. The antioxidant can be a phosphite-based antioxidant. In certain aspects phosphite-antioxidants include, but are not limited to, triphenyl phosphite, diphenylalkyl phosphites, phenyldialkyl phosphites, tris(nonylphenyl)phosphite, trilauryl phosphite, trioctadecyl phosphite, distearyl pentaerythritol diphosphite, tris(2,4-di-tert-butylphenyl)phosphite, diisodecyl pentaerythritol diphosphite, bis(2,4-di-tert-butylphenyl)pentaerythritol diphosphite tristearyl sorbitol triphosphite, and tetrakis(2,4-di-tertbutylphenyl)-4,4′-biphenylene diphosphonite, bis(2,4-dicumylphenyl)pentaerythritol diphosphite. The polymer blend can include an antioxidant in an amount of at least, equal to, and/or between any two of 0.1 wt %, 0.2 wt %, 0.3 wt %, 0.4 wt %, 0.5 wt %, 0.6 wt %, 0.7 wt %, 0.8 wt %, 0.9 wt %, and 0.1 wt % by total weight of the polymer blend. Non-limiting examples of commercially available antioxidants or heat stabilizers include Irganox 1010 and Irgaphos-168, both available from BASF, or Doverphos S9228T available from Dover Chemical Company.

Nucleating agents may also be used in the polymer blend. Nucleating agents may be considered as those additives that are added to polymers to facilitate crystal growth in the polymer melt. One or more nucleating agents may be used. Such nucleating agents may include, but are not limited, to cyclic dicarboxylate salts and talc. Talc is often used as a filler when used in higher amounts. When used in lower amounts (i.e., <5 wt %) talc acts as a nucleating agent. The use of the combination of a first nucleating agent of a cyclic dicarboxylate salt and a second nucleating agent of talc has been described in U.S. Pat. No. 11,136,446, which is herein incorporated by reference for all purposes. When such combination is used, the nucleating agents may be use in varying amounts. For example the weight ratio of the cyclic dicarboxylate salt to talc may range from 1:1200 to 2:1. The cyclic dicarboxylate salt may be used in an amount of from 0.0025 wt % to 0.1 wt % by total weight of the composition, with the talc nucleating agent being used in an amount of from 0.1 wt % to 5 wt %. An example of a suitable commercially available potassium salt of 1.2-cyclohexanedicarboxylic acid useful as a nucleating agent is that available as HYPERFORM® HPN 20E, from Milliken and Company.

In forming the PBT composition, the various components of the PBT composition, including the primary additives, as described, along with any additional optional secondary additives, can be dry blended. The PBT component may be in the form of pellets, powder, flakes or fluff. The materials are combined in a customary mixing machine, in which the PBT and primary additives are mixed with any optional additional or secondary additives. The optional secondary additives can be added at the end or during the processing steps to produce the polymer blend. Suitable machines for such mixing are known to those skilled in the art. Non-limiting examples include mixers, kneaders and extruders. These materials are then fed directly into the feed zone of an extruder. In certain cases, the process can be carried out in an extruder and introduction of the additives may occur during processing. Non-limiting examples of suitable extruders include single-screw extruders, counter-rotating and co-rotating twin-screw extruders, planetary-gear extruders, ring extruders, or co-kneaders. The process can be performed at a temperature from 240° C. to 300° C.

In some embodiments, the PBT component, primary additives, and any optional secondary additives, used to produce the PBT polymer blend of the present invention can be melt-extruded by following typical procedures of weighing the required amounts of the PBT and additives, followed by dry blending, and then feeding the mixture into a main feeder of a single-screw or twin-screw co-rotating extruder (length/diameter (L/D) ratio of 25:1 or 40:1) to obtain the final composition. The PBT, additives, or blend thereof can be subjected to an elevated temperature for a sufficient period of time during blending. The blending temperature can be above the melting point of the polymers. In certain aspects, the extrusion process can be performed at a temperature from 240° C. to 300° C. The primary and secondary additives can be in-line and prior to pelletization of the PBT resin during the production process. The amounts of additives combined with the PBT can be adjusted to provide those weight amounts previously discussed.

The optional secondary additives can be premixed or added individually to the polymer blend or the different components thereof. By way of example, the secondary additives of the present invention can be premixed such that the blend is formed prior to adding it to the PBT or the primary additives. The blend thereof can be subjected to an elevated temperature for a sufficient period of time during blending and/or incorporation of additives. Incorporation of optional secondary additives into the polymer resin can be carried out, for example, by mixing the above-described components using methods customary in process technology. The blending temperature can be above the melting point of the PBT polymers. In certain aspects, a process can be performed at a temperature from 240° C. to 270° C. Such “melt mixing” or “melt compounding” results in uniform dispersion of the present optional additives in the PBT and/or primary additives.

Articles that are manufactured from the PBT composition prepared as described can be used in high-frequency radio-wave applications of 6 GHz or greater. In particular, the PBT and/or articles formed therefrom may have a Dk value of 3.1, 3.0, 2.9, 2.8, 2.7, 2.6, 2.5, 2.4, 2.3, 2.2, 2.1, or 2.0 or less when measured at 6 GHz or higher. The PBT and/or articles formed therefrom may also have a Df value of 0.005, 0.004, 0.003, 0.002, 0.001, 0.0005 or less, when measured at 6 GHz or higher.

Additionally, the PBT composition and/or articles formed therefrom may have a metal adhesion peel strength of 0.1 N/mm, 0.2 N/mm, 0.3 N/mm, 0.4 N/mm, 0.5 N/mm or greater, as measured according to ASTM B533 or IPC-TM-650. The PBT composition or articles formed therefrom may have a CTE of 35 ppm/° C., 30 ppm/° C., 25 ppm/° C., 20 ppm/° C., 15 ppm/° C., 10 ppm/° C., 5 ppm/° C. or less, as measured according to ASTM D696. Furthermore, the PBT composition and/or articles formed therefrom may have a HDT at 1.8 MPa of 150° C., 160° C., 170° C., 180° C., 190° C., 200° C., 210° C., 220° C. or greater, as measured according to ASTM D648.

The PBT composition or article may also have a water absorption of 0.05 wt %, 0.04 wt %, 0.03 wt %, 0.02 wt %, 0.01 wt % or less by total weight, as measured according to ASTM D570. The composition or articles may also have a tensile modulus of 2000 MPa, 2100 MPa, 2200 MPa, 2300 MPa, 2400 MPa, 2500 MPa, 2600 MPa, 2700 MPa, 2800 MPa, 2900 MPa, 3000 MPa, 3100 MPa, 3200 MPa, 3300 MPa, 3400 MPa, 3500 MPa, 3600 MPa, 3700 MPa, 3800 MPa, 3900 MPa, 4000 MPa, 4100 MPa, 4200 MPa, 4300 MPa, 4400 MPa, 4500 MPa, 4600 MPa, 4700 MPa, 4800 MPa, 4900 MPa, 5000 MPa, 5100 MPa, 5200 MPa, 5300 MPa, 5400 MPa, 5500 MPa, 5600 MPa, 5700 MPa, 5800 MPa, 5900 MPa, 6000 MPa, 6100 MPa, 6200 MPa, 6300 MPa, 6400 MPa, 6500 MPa, 6600 MPa, 6700 MPa, 6800 MPa, 6900 MPa, 7000 MPa, 7100 MPa, 7200 MPa, 7300 MPa, 7400 MPa, 7500 MPa or more, as measured according to ASTM D638, and a tensile strength of 35 MPa, 40 MPa, 45 MPa, 50 MPa, 55 MPa, 60 MPa, 65 MPa, 70 MPa, 75 MPa, 80 MPa, 85 MPa, 90 MPa, 95 MPa, 100 MPa, 105 MPa, 110 MPa, 115 MPa, 120 MPa or more, as measured according to ASTM D638.

The PBT composition may have a density of 1.4 g/cc, 1.3 g/cc, or less. It may also have a UL94 flame retardance rating of V0@1.5 mm and a thermal conductivity of 0.05 W/mK, 0.1 W/mK, 0.15 W/mK, 0.2 W/mK, 0.25W/mK, 0.3 W/mK, 0.0.35 W/mK, 0.4 W/mK, 0.45 W/mK, 0.5 W/mK or higher, as measured according to ASTM C518.

The PBT composition may be useful for those particular applications at operating temperatures of −40° C. to 210° C. or higher.

The composition of the present disclosure can “comprise,” “consist essentially of,” or “consist of” particular ingredients, components, compositions, etc., disclosed throughout the specification.

The PBT compositions formed as described are normally collected as pellets, which can be stored for a time or employed immediately in a forming process. The forming processes can include injection molding, blow molding, compression molding, sheet extrusion, film blowing, pipe extrusion, profile extrusion, calendaring, thermoforming, rotomolding, or combinations thereof. The final formed PBT articles can be those used in high-frequency radio-wave applications of 6 GHz or greater. These may include, for instance, a telecommunication device or component, a high frequency (>6 GHz) electrical device, a high frequency (>6 GHz) multi-generational telecommunication device or component, a 5G or higher generation telecommunication antenna and end-use device or component, a telecommunication device housing, a radome cover, a radio-frequency (RF) filter, an RF connector, an EMI shield, an antenna substrate, a waveguide substrate or carrier, an antenna substrate in a base station antenna, and an automotive radar component.

While the invention has been shown in some of its forms, it should be apparent to those skilled in the art that it is not so limited but is susceptible to various changes and modifications without departing from the scope of the invention based on experimental data or other optimizations considering the overall economics of the process. Accordingly, it is appropriate that the appended claims be construed broadly and, in a manner, consistent with the scope of the invention.

1. A polybutylene terephthalate composition for use in high-frequency radio-wave applications of 6 GHz or greater, the composition comprising a mixture of a polybutylene terephthalate, hollow glass bubbles having an average diameter of from 5 microns to 80 microns, and at least one of glass fibers having a length of from 0.5 mm to 10 mm and a width or diameter of from 5 microns to 15 microns, aluminum oxide fibers having a length of from 1 mm to 5 mm and a width or diameter of from 1 micron to 30 microns, a polyethylene terephthalate and a polycarbonate.

2. The composition of claim 1, wherein:
the composition includes the hollow glass bubbles in an amount of from 1 wt % to 35 wt %.

3. The composition of claim 2, wherein:
the hollow glass bubbles have at least one of a crush strength of 30 MPa or more as measured by QCM;
a true density of from 0.3 g/cc to 0.8 g/cc as measured by helium pycnometry; and
a gas volume of from 50% to 90% as measured by QCM.

4. The composition of claim 3, wherein:
the composition includes the glass fibers in an amount of 40 wt % or less by total weight of the composition.

5. The composition of claim 4, wherein:
the glass fibers have a dielectric constant (Dk) of 6 or lower as measured according to ASTM D150 at 6 MHz or higher.

6. The composition of claim 5, wherein:
the composition includes the aluminum oxide fibers in an amount of 40 wt % or less by total weight of the composition.

7. The composition of claim 6, wherein:
the polybutylene terephthalate is a low intrinsic viscosity (IV) resin with an IV of 1.4 dl/g or less or a high IV resin with an IV of 1.5 dl/g or more or a mixture of such resins, as measured in dilute solution using capillary viscometers following ISO-1628-5 protocol.

8. The composition of claim 7, wherein:
the composition includes the polycarbonate in an amount of 30 wt % or less by total weight of the composition.

9. The composition of claim 8, wherein:
the composition includes the polyethylene terephthalate in an amount of 30 wt % or less by total weight of the composition.

10. The composition of claim 9, further comprising:
at least one of a stabilizing agent, a coupling agent, a nucleating agent, a heat conductive agent, a fire retardant additive, a thermally conductive additive, a tie agent, an antiblocking agent, an antistatic agent, an antioxidant, a neutralizing agent, an acid scavenger, a blowing agent, a crystallization aid, a dye, a flame retardant agent, a filler, a hard filler, a soft filler, an impact modifier, a mold release agent, an oil, another polymer, a pigment, a processing agent, a reinforcing agent, a light stabilizer, an UV resistance agent, a slip agent, a flow modifying agent, and combinations thereof.

11. The composition of claim 1, wherein:
the polybutylene terephthalate composition has a Dk value of 2.5 or less, when measured at 6 GHz or higher, and a Df value of 0.005 or less, when measured at 6 GHz or higher, and at least one of the following:
a metal adhesion peel strength of 0.1 N/mm or greater, as measured according to ASTM B533 or IPC-TM-650,
a coefficient of thermal expansion (CTE) of 35 ppm/° C. or less, as measured according to ASTM D696;
a heat deflection temperature (HDT) of 200° C. or greater, as measured according to ASTM D648;
water absorption of 0.05 wt % or less, as measured according to ASTM D570;
a tensile modulus of 2000 MPa or more, as measured according to ASTM D638;
a tensile strength of 35 MPa or more, as measured according to ASTM D638;
a density of 1.4 g/cc or less;
a UL94 flame retardance rating of V0@1.5 mm; and
a thermal conductivity of 0.3 W/mK or greater, as measured according to ASTM C518.

12. (canceled)

13. (canceled)

14. A method of forming a polybutylene terephthalate composition for use in high-frequency radio-wave applications of 6 GHz or greater, the method comprising modifying a polybutylene terephthalate by melt blending the polybutylene terephthalate with materials of hollow glass bubbles having an average diameter of 5 microns to 80 microns, and at least one of glass fibers having a length of from 0.5 mm to 10 mm and a width or diameter of from microns to 15 microns, aluminum oxide fibers having a length of from 1 mm to 5 mm and a width or diameter of from 1 micron to 30 microns, and a polycarbonate.

15. The composition of claim 4, wherein the glass fibers have a dissipation factor (Df) of 0.005 or less, as measured according to ASTM D150 at 6 MHz or higher.

16. The composition of claim 4, wherein the glass fibers have a coefficient of thermal expansion (CTE) of 35×10⁻⁶/° C. or less, as measured according to ASTM D696.

17. The method of claim 14, wherein the method is performed at a temperature from 240° C. to 270° C.

18. The method of claim 14, wherein the melt blending step is performed in such a way to create a uniform composition.

19. The method of claim 14, wherein the composition includes the polycarbonate in an amount of 30 wt % or less by total weight of the composition.

20. The method of claim 14, wherein the composition includes the hollow glass bubbles in an amount of 35 wt % or less and the glass fibers in an amount of 40 wt % or less by total weight of the composition.

21. An article of manufacture comprising the polybutylene terephthalate of claim 1.

22. The article of manufacture of claim 21 comprising at least one of a telecommunication device, a component of a telecommunication device, a high frequency (>6 GHz) electrical device, a high frequency (>6 GHz) multi-generational telecommunication device, a component of a high frequency (>6 GHz) multi-generational telecommunication device, a 5G or higher generation telecommunication device, a component of a 5G or higher generation telecommunication device, a housing of a telecommunication device, a radome cover, a radio-frequency (RF) filter, an RF connector, an EMI shield, an antenna substrate, a waveguide substrate, a waveguide carrier, and an automotive radar component.
